(19) United States
(12) Patent Application Publication
(10) Pub. No.: US 2025/0158698 A1
(43) Pub. Date: May 15, 2025

(54) NETWORK CONTROLLED REPEATER CONFIGURATION

(71) Applicant: Lenovo (Singapore) Pte. Limited, Singapore (SG)

(72) Inventors: Ali Ramadan Ali, Kraiburg (DE); Hossein Bagheri, Urbana, IL (US); Ahmed Hindy, Aurora, IL (US); Vijay Nangia, Woodridge, IL (US)

(73) Assignee: Lenovo (Singapore) Pte. Limited, Singapore (SG)

(21) Appl. No.: 18/728,747

(22) PCT Filed: Jan. 12, 2023
(86) PCT No.: PCT/IB2023/050296

§ 371 Date: Jul. 12, 2024

Related U.S. Application Data
(60) Provisional application No. 63/298,976, filed on Jan. 12, 2022.

(51) Int. Cl. H04B 7/155; H04W 52/46; H04W 72/232

(52) U.S. Cl. CPC H04B 7/15528; H04W 52/46; H04W 72/232

(57) ABSTRACT

Various aspects of the present disclosure relate to a repeater node in a network that receives a first configuration of common control search space. and receives a second configuration of control search space for control information. The first configuration of the common control search space indicates where to locate the second configuration of the control search space. as well as decoding information to decode repeater dedicated downlink control information. A controller of the repeater decodes the control information from the second configuration of the control search space as repeater downlink control information. The controller of the repeater can then apply the control information on a forwarded link between a base station and a user equipment.

### RELATED APPLICATION

This application claims priority to U.S. Patent Application Ser. No. 63/298,976 filed Jan. 12, 2022 entitled “Network Controlled Repeater Configuration,” the disclosure of which is incorporated by reference herein in its entirety.

### TECHNICAL FIELD

The present disclosure relates to wireless communications, and more specifically to a repeater configuration controlled by the network.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, subslots, slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Wireless communication coverage is a fundamental aspect of cellular network deployments, and mobile operators rely on different types of network nodes to facilitate blanket coverage of wireless communications systems deployments. Deployment of regular, full-stack cells is one option, but it may not always be possible due to the lack of availability of backhaul, or may not be economically viable. As a result, different types of network nodes are under consideration to increase the coverage flexibility for network deployments by mobile operators. For example, integrated access and backhaul (IAB) is a recent type of network node that does not require a wired backhaul. Another type of network node is the RF repeater, which simplifies the amplify-and-forward of any signal that the repeater receives. The RF repeaters have been utilized in 2G, 3G, and 4G systems to supplement the coverage provided by regular full-stack cells, and radio frequency (RF) and electromagnetic compatibility (EMC) requirements are specified for RF repeaters for new radio (NR), targeting both frequency range one (FR1) and frequency range two (FR2). Although an RF repeater provides a cost effective solution for extending network coverage, a conventional RF repeater is limited, typically implemented to simply perform an amplify-and-forward operation.

### SUMMARY

The present disclosure relates to methods, apparatuses, and systems that enable a network entity, such as a base station, to control a repeater configuration. In a wireless communications system, RF repeaters are a cost effective solution for extending network coverage for new radio (NR), and the repeaters are implemented and utilized to increase and enhance coverage flexibility for wireless communications systems deployments, as specified for both frequency range one (FR1) and frequency range two (FR2). As described in aspects of this disclosure, a network-controlled repeater is an enhancement over conventional RF repeaters, having the capability to receive and process side control information from the network (e.g., a base station, gNB). The side control information provides that a network-controlled repeater can perform an amplify-and-forward operation in a more efficient manner, facilitating the benefits of mitigation of unnecessary noise amplification, transmissions and receptions with better spatial directivity, and simplified network integration. The capabilities of network-controlled repeaters (RF repeaters) can be enhanced to efficiently extend the network coverage in both uplink and downlink communication utilizing side control information from the network for an amplify-and-forward technique that uses the time and spatial information of the Uu interface (also referred to as the Uu link).

Some implementations of the method and apparatuses described herein may further include an apparatus (e.g., a repeater) that receives, from a base station, a first configuration of common control search space, and receives a second configuration of control search space for control information, the first configuration of the common control search space indicating to the repeater where to locate the second configuration of the control search space. A controller of the repeater decodes the control information from the second configuration of the control search space as repeater downlink control information (DCI), and the controller can then apply the control information on a forwarded link between a base station and a user equipment.

In some implementations of the method and apparatuses described herein, a repeater common control resource set (CORESET) carries the repeater DCI located in the common control search space of the first configuration. The control search space of the second configuration is a dedicated search space, and a repeater dedicated CORESET carries repeater dedicated DCI located in the dedicated search space. A repeater common CORESET carries the repeater DCI that indicates how to decode the second configuration of the control search space.

Some implementations of the method and apparatuses described herein may further include an apparatus (e.g., a base station, gNB) transmitting to a repeater. The base station transmits, to a repeater, a first configuration of common control search space, and transmits, to the repeater, a second configuration of control search space for control information. The first configuration of the common control search space indicates to the repeater where to locate the second configuration of the control search space and decode the control information from the second configuration of the control search space as repeater DCI usable to control a forwarded link between the apparatus and the user equipment.

### BRIEF DESCRIPTION OF THE DRAWINGS

Various aspects of the present disclosure for network controlled repeater configuration are described with reference to the following Figures. The same numbers may be used throughout to reference like features and components shown in the Figures.

FIG. 1 illustrates an example of a wireless communications system that supports network controlled repeater configuration in accordance with aspects of the present disclosure.

FIG. 2 illustrates an example of a system that supports network controlled repeater configuration and may use the wireless communications system in accordance with aspects of the present disclosure.

FIG. 3 illustrates an example of a repeater common CORESET location that supports network controlled repeater configuration in accordance with aspects of the present disclosure.

FIG. 4 illustrates an example of the repeater CORESET periodicity and an indication of repeater dedicated CORESET configuration that supports network controlled repeater configuration in accordance with aspects of the present disclosure.

FIG. 5 illustrates an example of time information indication that supports network controlled repeater configuration in accordance with aspects of the present disclosure.

FIG. 6 illustrates an example block diagram of components of a device (e.g., a repeater) that supports network controlled repeater configuration in accordance with aspects of the present disclosure.

FIG. 7 illustrates an example block diagram of components of a device (e.g., a base station) that supports network controlled repeater configuration in accordance with aspects of the present disclosure.

FIGS. 8 and 9 illustrate flowcharts of methods that support network controlled repeater configuration in accordance with aspects of the present disclosure.

### DETAILED DESCRIPTION

Implementations of network controlled repeater configuration are described as related to a repeater configuration of an RF repeater controlled by a network entity, such as a base station (e.g., gNB). In a wireless communications system, RF repeaters are a cost effective solution for extending network coverage for new radio (NR), and the repeaters are implemented and utilized to increase and enhance coverage flexibility for wireless communications systems deployments, as specified for both frequency range one (FR1) and frequency range two (FR2). Although an RF repeater provides a cost effective solution for extending network coverage, a conventional repeater is limited, typically implemented to simply perform an amplify-and-forward operation without an ability to take into account various factors that could improve performance. These factors may include information about semi-static and/or dynamic downlink or uplink configuration, adaptive transmitter and/or receiver spatial beamforming, on-off status, and other performance improving factors.

As described in aspects of this disclosure, a network-controlled repeater is an enhancement over conventional RF repeaters, having the capability to receive and process side control information from the network (e.g., a base station, gNB). The side control information provides that a network-controlled repeater can perform an amplify-and-forward operation in a more efficient manner, facilitating the benefits of mitigation of unnecessary noise amplification, transmissions and receptions with better spatial directivity, and simplified network integration. The capabilities of network-controlled repeaters (RF repeaters) can be enhanced to efficiently extend the network coverage in both uplink and downlink communication utilizing side control information from the network for an amplify-and-forward technique that uses the time and spatial information of the Uu interface (also referred to as the Uu link). The side control information may include time-division duplexing (TDD) switching, timing information, power control, as well as common and UE dedicated spatial information for beamforming.

In aspects of the described techniques, a controller of the repeater is utilized as a new type of UE device with limited UE capability to decode some Uu link channels for controlling the repeater using Uu link. The controller of the repeater can detect a synchronization signal block (SSB) for synchronizing to the network, decoding master information block (MIB) information, system information block (SIB) information, and decoding a physical downlink control channel (PDCCH) that carries side control information to the repeater. Given that cost efficiency is the key consideration, the repeater is expected to have a low complexity receiver to decode the side control information. Therefore, the repeater is not expected to decode UE dedicated control resource set (CORESET) that requires blind search as well as having the cell radio network temporary identity (C-RNTI) and other configurations for each UE.

Accordingly, controller configuration enhancements and/or a repeater specific CORESET design can be implemented on the PDCCH framework to carry the side control information from the base station to the repeater. Further, by utilizing a portion of the Uu interface to control a repeater, a controller of a repeater can decode the control information with low complexity based in part on some modifications of the framework of control channels on the Uu link. In aspects of the disclosure, a repeater specific CORESET design with the corresponding downlink control information (DCI) for controlling a repeater is implemented. The described techniques for network controlled repeater configuration include a new design of repeater down link control channel search spaces and the corresponding CORESETs; a repeater dedicated DCI for carrying side control information to each repeater; common DCI for carrying initial configuration information to all repeaters in the network for decoding the repeater dedicated DCI; and configuration of repeater control search space in SIB.

Controlling a repeater configuration by the network (e.g., a base station, gNB) takes into account various scenarios and assumptions for NR network controlled repeaters. For example, the network controlled repeaters are in-band RF repeaters used for extension of network coverage on multiple bands (e.g., FR1 and FR2 bands), and FR2 deployments may be prioritized for both outdoor and O2I scenarios. The described techniques for network controlled repeaters may apply to single hop stationary network-controlled repeaters; the network controlled repeaters are transparent to UEs; and a network controlled repeater can maintain the gNB-repeater link and the repeater-UE link simultaneously. Cost efficiency as related to both the cost of a transceiver and the cost of efficient deployment is also a key consideration point for network-controlled repeaters.

Other considerations for network controlled repeaters include to identify which side control information is necessary for network controlled repeaters, including an assumption of max transmission power. For example, the side control information may include beamforming information; timing information to align the transmission and/or reception boundaries of a network controlled repeater; information pertaining to uplink-downlink TDD (UL-DL TDD) configuration; ON-OFF information for efficient interference management and improved energy efficiency; and power control information for efficient interference management. Another consideration, and a focus of this disclosure, is to identify the layer one and layer two (L1/L2) signaling, including its configuration, to carry the side control information. Other aspects of network controlled repeater management include the identification and authorization of network-controlled repeaters (e.g., as pertaining to RAN2, RAN3) and coordination with SA3 may be needed.

Aspects of the present disclosure are described in the context of a wireless communications system. Aspects of the present disclosure are further illustrated and described with reference to device diagrams and flowcharts that relate to network controlled repeater configuration.

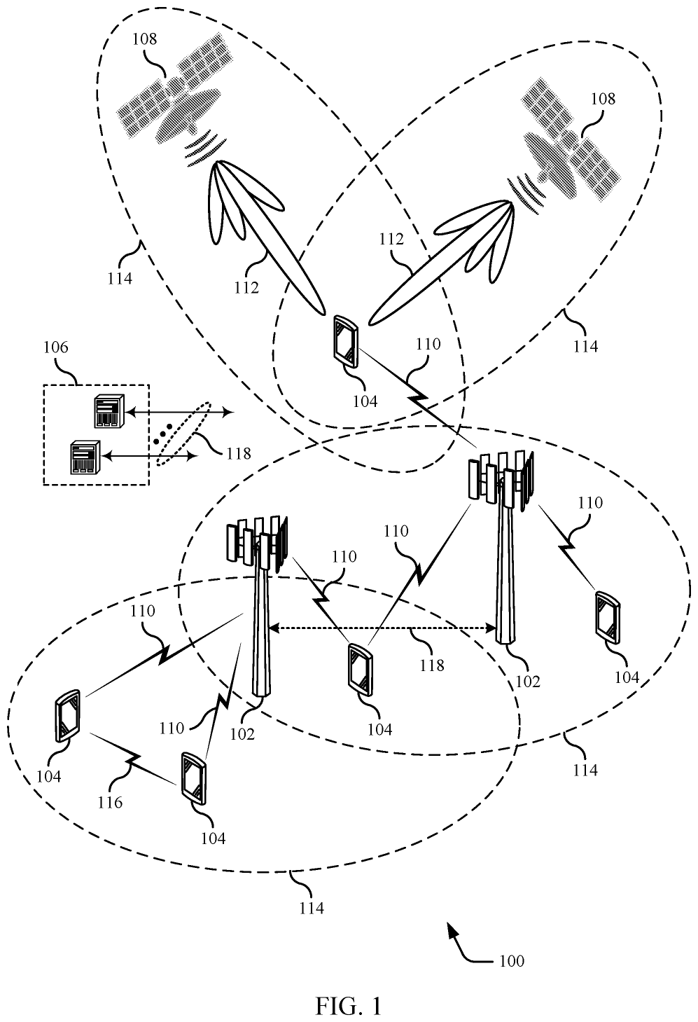

FIG. 1 illustrates an example of a wireless communications system 100 that supports network controlled repeater configuration in accordance with aspects of the present disclosure. The wireless communications system 100 may include one or more base stations 102, one or more UEs 104, a core network 106, and one or more non-terrestrial stations (NTSs) 108, such as satellite access nodes. The wireless communications system 100 may support various radio access technologies (RATs). In some implementations, the wireless communications system 100 may be a 4G network, such as an LTE network or an LTE-A network. In some other implementations, the wireless communications system 100 may be a 5G network, such as a NR network. In other implementations, the wireless communications system 100 may be a combination of a 4G network and a 5G network. The wireless communications system 100 may support RATs beyond 5G. Additionally, the wireless communications system 100 may support technologies, such as time division multiple access (TDMA), frequency division multiple access (FDMA), or code division multiple access (CDMA), etc.

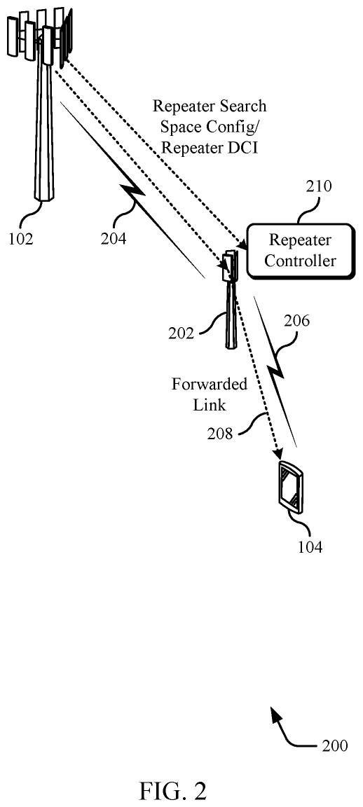

The one or more base stations 102 may be dispersed throughout a geographic region to form the wireless communications system 100. One or more of the base stations 102 described herein may be, or include, or may be referred to as a base transceiver station, an access point, a NodeB, an eNB, a gNB, or other suitable terminology. A base station 102 and a UE 104 may communicate via a communication link 110, which may be a wireless or wired connection. For example, a base station 102 and a UE 104 may perform wireless communication over a NR-Uu interface. As further shown and described with reference to FIG. 2, a repeater node may be implemented to extend or enhance network coverage of a communication link 110 between a base station 102 and a UE 104, where a base station 102 communicates with a repeater, and the repeater further communicates with a UE 104 via a communication link.

The one or more NTSs 108 described herein may be or include any type of TRPs (which may be onboard geostationary and/or geosynchronous (GEO) satellites), MEO satellites, LEO satellites, HAPS, UAV, aircraft, or any other vehicle travelling in the earth's atmosphere, orbiting in outer space, and the like. Any entity referred to as a non-terrestrial station (NTS) in the present disclosure may be referring to a satellite, a satellite access node, NTN node, NG-RAN node, NT-TRP, NTN TP, NTN RP, and similar type entities. A NTS 108 and a UE 104 may communicate via a communication link 112, which may be a wireless connection via a transmission beam and/or a reception beam.

A base station 102 and/or a NTS 108 may provide a geographic coverage area 114 for which the base station 102 and/or the NTS 108 may support services (e.g., voice, video, packet data, messaging, broadcast, etc.) for one or more UE 104 within the geographic coverage area. For example, a base station 102 and a UE 104 may support wireless communication of signals related to services (e.g., voice, video, packet data, messaging, broadcast, etc.) according to one or multiple radio access technologies. Similarly, a NTS 108 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite associated with an NTN. In some implementations, different geographic coverage areas 114 associated with the same or different radio access technologies may overlap, and different geographic coverage areas 114 may be associated with different base stations 102 and/or with different NTSs 108. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 114 of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100, such as a very small aperture terminal (VSAT), which may be connected to one or multiple other network nodes serving other UEs. In other implementations, a UE 104 may be mobile in the wireless communications system 100, such as an earth station in motion (ESIM).

The one or more UEs 104 may be devices in different forms or having different capabilities. A UE 104 may be capable of communicating with various types of devices, such as the base stations 102, other UEs 104, NTSs 108, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UE 104, which may act as relays in the wireless communications system 100.

A UE 104 may also support wireless communication directly with other UE 104 over a communication link 116. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 116 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 118 (e.g., via an S1, N2, or other network interface). The base stations 102 may communicate with each other over the backhaul links 118 (e.g., via an X2, Xn, or another network interface). In some implementations, the base stations 102 may communicate with each other directly (e.g., between the base stations 102). In some other implementations, the base stations 102 and/or NTSs 108 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as a radio heads, smart radio heads, gateways, TRPs, and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

In at least one implementation, one or more of the UEs 104, the base stations 102, and/or one or more repeaters are operable to implement various aspects of network controlled repeater configuration, as described herein. For instance, leveraging the described techniques, a base station 102 is operable to control the configuration of a repeater in the wireless communications system 100.

FIG. 2 illustrates an example of a system 200 that supports network controlled repeater configuration in accordance with aspects of the present disclosure. The system 200 may use the wireless communications system 100 and/or be implemented with the wireless communications system. The system 200 includes a base station 102 that communicates with a repeater 202 via a communication link 204, and the repeater 202 further communicates with a UE 104 via a communication link 206. For example, the base station 102, the repeater 202, and the UE 104 may perform wireless communication of a forwarded link 208 over a Uu interface. Further, the base station 102 communicates repeater search space configuration and repeater downlink control information (DCI) to a controller 210 of the repeater via the communication link 204.

In aspects of the described techniques, the controller 210 of the repeater 202 is utilized as a new type of UE device with limited UE capability to decode some Uu link channels for controlling the repeater using Uu link. The controller 210 of the repeater 202 can detect a synchronization signal block (SSB) for synchronizing to the network, decoding master information block (MIB) information, system information block (SIB) information, and decoding a physical downlink control channel (PDCCH) that carries side control information to the repeater. Given that cost efficiency is the key consideration, the repeater is expected to have a low complexity receiver to decode the side control information. Therefore, the repeater is not expected to decode UE dedicated control resource set (CORESET) that requires blind search as well as having the cell radio network temporary identity (C-RNTI) and other configurations for each UE.

Accordingly, controller configuration enhancements and/or a repeater specific CORESET design can be implemented on the PDCCH framework to carry the side control information from the base station 102 to the repeater 202. Further, by utilizing a portion of the Uu interface to control the repeater, the controller 210 of the repeater 202 can decode the control information with low complexity based in part on some modifications of the framework of control channels on the Uu link. In aspects of the disclosure, a repeater specific CORESET design with the corresponding downlink control information (DCI) for controlling the repeater is implemented. The described techniques for network controlled repeater configuration include a new design of repeater down link control channel search spaces and the corresponding CORESETs; a repeater dedicated DCI for carrying side control information to each repeater; common DCI for carrying initial configuration information to all repeaters in the network for decoding the repeater dedicated DCI; and configuration of repeater control search space in SIB. The repeater can decode SSB, synchronize to the network, and decode CORESET0 to receive the basic or initial network configuration, which may include carrier frequency, initial bandwidth (BWP), SCS sub-carrier spacing, frame number, cell ID etc.

The UE 104 is typically implemented with procedures for receiving control information and determining or decoding a physical downlink control channel (PDCCH) (e.g., [TS 38.213]). If the UE is configured with a secondary cell group (SCG), the UE can apply the procedures for both master cell group (MCG) and SCG, except for PDCCH monitoring in Type0/0A/2-PDCCH common cell space (CSS) sets where the UE is not required to apply the procedures for the SCG. When the procedures are applied for MCG, the terms ‘secondary cell’, ‘secondary cells’, ‘serving cell’, and ‘serving cells’ refer to secondary cell, secondary cells, serving cell, and serving cells belonging to the MCG, respectively. When the procedures are applied for SCG, the terms ‘secondary cell’, ‘secondary cells’, ‘serving cell’, and ‘serving cells’ refer to secondary cell, secondary cells (not including PSCell), serving cell, and serving cells belonging to the SCG, respectively. The term ‘primary cell’ refers to the PSCell of the SCG.

A UE monitors a set of PDCCH candidates in one or more CORESETs on the active downlink bandwidth part (DL BWP) on each activated serving cell configured with PDCCH monitoring according to corresponding search space sets, where monitoring implies decoding each PDCCH candidate according to the monitored DCI formats. If a UE is provided monitoringCapabilityConfig for a serving cell, the UE obtains an indication to monitor PDCCH on the serving cell for a maximum number of PDCCH candidates and non-overlapping control channel elements (CCEs). For example, per slot (Tables 10.1-2 and 10.1-3) if monitoringCapabilityConfig=r15monitoringcapability; or per span (Tables 10.1-2A and 10.1-3A) if monitoringCapabilityConfig=r16monitoringcapability. If the UE is not provided monitoringCapabilityConfig, the UE monitors PDCCH on the serving cell for a maximum number of PDCCH candidates and non-overlapping CCEs per slot.

A UE indicates a capability to monitor PDCCH according to one or more of the combinations (X, Y)=(2, 2), (4, 3), and (7, 3) per SCS configuration of μ=0 and μ=1. A span is a number of consecutive symbols in a slot where the UE is configured to monitor PDCCH, and each PDCCH monitoring occasion is within one span. If a UE monitors PDCCH on a cell according to combination (X, Y), the UE supports PDCCH monitoring occasions in any symbol of a slot with minimum time separation of X symbols between the first symbol of two consecutive spans, including across slots. A span starts at a first symbol where a PDCCH monitoring occasion starts and ends at a last symbol where a PDCCH monitoring occasion ends, where the number of symbols of the span is up to Y.

If a UE indicates a capability to monitor PDCCH according to multiple (X, Y) combinations, and a configuration of search space sets to the UE for PDCCH monitoring on a cell results to a separation of every two consecutive PDCCH monitoring spans that is equal to or larger than the value of X for one or more of the multiple combinations (X, Y), then the UE monitors PDCCH on the cell according to the combination (X, Y), from the one or more combinations (X, Y), that is associated with the largest maximum number of M_{PDCCH}^{max,(X,Y),μ} and C_{PDCCH}^{max,(X,Y),μ} (Table 10.1-2A and Table 10.1-3A). The UE expects to monitor PDCCH according to the same combination (X, Y) in every slot on the active DL BWP of a cell.

A UE capability for PDCCH monitoring per slot or per span on an active DL BWP of a serving cell is defined by a maximum number of PDCCH candidates and non-overlapped CCEs, and the UE can monitor per slot or per span, respectively, on the active DL BWP of the serving cell. For monitoring of a PDCCH candidate by a UE, if the UE has received ssb-PositionsInBurst in system information block1 (SIB1) and has not received ssb-PositionsInBurst in ServingCellConfigCommon for a serving cell, and does not monitor PDCCH candidates in a Type0-PDCCH CSS set, and at least one resource element (RE) for a PDCCH candidate overlaps with at least one RE of a candidate synchronization signal/physical broadcast channel (SS/PBCH) block corresponding to a SS/PBCH block index provided by ssb-PositionsInBurst in SIB1, then the UE is not required to monitor the PDCCH candidate. For monitoring of a PDCCH candidate by a UE, if the UE has received ssb-PositionsInBurst in ServingCellConfigCommon for a serving cell, and does not monitor PDCCH candidates in a Type0-PDCCH CSS set, and at least one RE for a PDCCH candidate overlaps with at least one RE of a candidate SS/PBCH block corresponding to a SS/PBCH block index provided by ssb-PositionsInBurst in ServingCellConfigCommon, then the UE is not required to monitor the PDCCH candidate.

If a UE monitors the PDCCH candidate for a Type0-PDCCH CSS set on the serving cell according to the procedure (described in clause 13, for example), then the UE may assume that no SS/PBCH block is transmitted in REs used for monitoring the PDCCH candidate on the serving cell. If at least one RE of a PDCCH candidate for a UE on the serving cell overlaps with at least one RE of lte-CRS-ToMatchAround, or of LTE-CRS-PatternList, the UE is not required to monitor the PDCCH candidate. If a UE is provided availableRB-SetsPerCell, the UE is not required to monitor PDCCH candidates that overlap with any RB from RB sets that are indicated as unavailable for receptions by an available RB set indicator field in DCI format 2_0 (described in clause 11.1.1, for example). If the UE does not obtain the available RB set indicator for a symbol, the UE monitors PDCCH candidates on all RB sets in the symbol.

If a UE can support a first set of N_{cells,0}^{DL} serving cells where the UE is either not provided coresetPoolIndex or is provided coresetPoolIndex with a single value for all CORESETs on all DL BWPs of each scheduling cell from the first set of serving cells, and a second set of N_{cells,1}^{DL} serving cells where the UE is not provided coresetPoolIndex or is provided coresetPoolIndex with a value 0 for a first CORESET, and with a value/for a second CORESET on any DL BWP of each scheduling cell from the second set of serving cells, then the UE determines, for the purpose of reporting pdcch-BlindDetectionCA, a number of serving cells as N_{cells,0}^{DL}+R·N_{cells,1}^{DL} where R is a value reported by the UE.

If a UE indicates in UE-NR-Capability a carrier aggregation capability larger than four serving cells and the UE is not provided monitoringCapabilityConfig for any downlink cell, or if the UE is provided monitoringCapabilityConfig=r15monitoringcapability for all downlink cells where the UE monitors PDCCH, then the UE includes in UE-NR-Capability an indication for a maximum number of PDCCH candidates. For a maximum number of non-overlapped CCEs, the UE can monitor per slot when the UE is configured for carrier aggregation operation over more than four cells. When a UE is not configured for NR-DC operation, the UE determines a capability to monitor a maximum number of PDCCH candidates and a maximum number of non-overlapped CCEs per slot that corresponds to N_{cells}^{cap} downlink cells, where N_{cells}^{cap} is N_{cells,0}^{DL}+R·N_{cells,1}^{DL} if the UE does not provide pdcch-BlindDetectionCA where N_{cells,0}^{DL}+N_{cells,1}^{DL} is the number of configured downlink serving cells, otherwise N_{cells}^{cap} is the value of pdcch-BlindDetectionCA.

When a UE is configured for NR-DC operation, the UE determines a capability to monitor a maximum number of PDCCH candidates and a maximum number of non-overlapped CCEs per slot that corresponds to N_{cells}^{cap}=N_{cells}^{MCG} downlink cells for the MCG where N_{cells}^{MCG} is provided by pdcch-BlindDetection for the MCG and determines a capability to monitor a maximum number of PDCCH candidates and a maximum number of non-overlapped CCEs per slot that corresponds to N_{cells}^{cap}=N_{cells}^{SCG} downlink cells for the SCG where N_{cells}^{SCG} is provided by pdcch-BlindDetection for the SCG. When the UE is configured for carrier aggregation operation over more than four cells, or for a cell group when the UE is configured for NR-DC operation, the UE does not expect to monitor per slot a number of PDCCH candidates or a number of non-overlapped CCEs that is larger than the maximum number as derived from the corresponding value of N_{cells}^{cap}.

The UE 104 is also implemented with procedures for determining PDCCH assignment. A set of PDCCH candidates for a UE to monitor is defined in terms of PDCCH search space sets. A search space set can be a common search space (CSS) set or a UE-specific Search Space (USS) set. A UE monitors PDCCH candidates in one or more of the following search spaces sets: A Type0-PDCCH CSS set configured by pdcch-ConfigSIB1 in MIB or by searchSpaceSIB1 in PDCCH-ConfigCommon or by searchSpaceZero in PDCCH-ConfigCommon for a DCI format with cyclic redundancy check (CRC) scrambled by a system information-radio network temporary identity (SI-RNTI) on the primary cell of the MCG. A Type0A-PDCCH CSS set configured by searchSpaceOtherSystemInformation in PDCCH-ConfigCommon for a DCI format with CRC scrambled by a SI-RNTI on the primary cell of the MCG. A Type1-PDCCH CSS set configured by ra-SearchSpace in PDCCH-ConfigCommon for a DCI format with CRC scrambled by a RA-RNTI, a MsgB-RNTI, or a TC-RNTI on the primary cell. A Type2-PDCCH CSS set configured by pagingSearchSpace in PDCCH-ConfigCommon for a DCI format with CRC scrambled by a P-RNTI on the primary cell of the MCG. A Type3-PDCCH CSS set configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, or CI-RNTI and, only for the primary cell, C-RNTI, MCS-C-RNTI, CS-RNTI(s), or PS-RNTI. A USS set configured by SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL Semi-Persistent Scheduling V-RNTI.

For a DL BWP, if a UE is not provided searchSpaceSIBI for Type0-PDCCH CSS set by PDCCH-ConfigCommon, the UE does not monitor PDCCH candidates for a Type0-PDCCH CSS set on the DL BWP. The Type0-PDCCH CSS set is defined by the CCE aggregation levels and the number of PDCCH candidates per CCE aggregation level (Table 10.1-1). If the active DL BWP and the initial DL BWP have the same SCS and the same CP length, and the active DL BWP includes all RBs of the CORESET with index 0, or the active DL BWP is the initial DL BWP, the CORESET configured for Type0-PDCCH CSS set has CORESET index 0 and the Type0-PDCCH CSS set has search space set index 0.

TABLE 10.1-1
CCE aggregation levels and maximum number of
PDCCH candidates per CCE aggregation level
for CSS sets configured by searchSpaceSIB1

| CCE Aggregation Level | Number of Candidates |
|---|---|
| 4 | 4 |
| 8 | 2 |
| 16 | 1 |

For a DL BWP, if a UE is not provided searchSpaceOtherSystemInformation for Type0A-PDCCH CSS set, the UE does not monitor PDCCH for Type0A-PDCCH CSS set on the DL BWP. The CCE aggregation levels and the number of PDCCH candidates per CCE aggregation level for Type0A-PDCCH CSS set is given (Table 10.1-1). For a DL BWP, if a UE is not provided ra-SearchSpace for Type1-PDCCH CSS set, the UE does not monitor PDCCH for Type1-PDCCH CSS set on the DL BWP. If the UE has not been provided a Type3-PDCCH CSS set or a USS set and the UE has received a C-RNTI and has been provided a Type1-PDCCH CSS set, the UE monitors PDCCH candidates for DCI format 0_0 and DCI format 1_0 with CRC scrambled by the C-RNTI in the Type1-PDCCH CSS set.

If a UE is not provided pagingSearchSpace for Type2-PDCCH CSS set, the UE does not monitor PDCCH for Type2-PDCCH CSS set on the DL BWP. The CCE aggregation levels and the number of PDCCH candidates per CCE aggregation level for Type2-PDCCH CSS set are given (Table 10.1-1). If a UE is provided a zero value for searchSpacell) in PDCCH-ConfigCommon for a Type0/0A/2-PDCCH CSS set, the UE determines monitoring occasions for PDCCH candidates of the Type0/0A/2-PDCCH CSS set (e.g., described in clause 13, for example), and the UE is provided a C-RNTI. The UE monitors PDCCH candidates only at monitoring occasions associated with a SS/PBCH block, where the SS/PBCH block is determined by the most recent of a MAC CE activation command indicating a TCI state of the active BWP that includes a CORESET with index 0 (e.g., described in [6, TS 38.214]), where the TCI-state includes a CSI-RS which is quasi-co-located with the SS/PBCH block, or a random access procedure that is not initiated by a PDCCH order that triggers a contention-free random access procedure.

If a UE monitors PDCCH candidates for DCI formats with CRC scrambled by a C-RNTI and the UE is provided a non-zero value for searchSpaceID in PDCCH-ConfigCommon for a Type0/0A/2-PDCCH CSS set, the UE determines monitoring occasions for PDCCH candidates of the Type0/0A/2-PDCCH CSS set based on the search space set associated with the value of searchSpaceID. The UE may assume that the DM-RS antenna port associated with PDCCH receptions in the CORESET configured by pdcch-ConfigSIB1 in MIB, the DM-RS antenna port associated with corresponding PDSCH receptions, and the corresponding SS/PBCH block are quasi co-located with respect to average gain, quasi co-location ‘typeA’ and ‘typeD’ properties, when applicable (e.g., [6, TS 38.214]), if the UE is not provided a TCI state indicating quasi co-location information of the DM-RS antenna port for PDCCH reception in the CORESET. The value for the DM-RS scrambling sequence initialization is the cell ID, and a SCS is provided by subCarrierSpacingCommon in MIB.

For single cell operation or for operation with carrier aggregation in a same frequency band, a UE does not expect to monitor a PDCCH in a Type0/0A/2/3-PDCCH CSS set or in a USS set if a DM-RS for monitoring a PDCCH in a Type1-PDCCH CSS set is not configured with same qcl-Type set to ‘typeD’ properties (e.g., [6, TS 38.214]) with a DM-RS for monitoring the PDCCH in the Type0/0A/2/3-PDCCH CSS set or in the USS set, and if the PDCCH or an associated PDSCH overlaps in at least one symbol with a PDCCH, then the UE monitors in a Type1-PDCCH CSS set or with an associated PDSCH.

If a UE is provided one or more search space sets by corresponding one or more of searchSpace Zero, searchSpaceSIB1, searchSpaceOtherSystemInformation, pagingSearchSpace, ra-SearchSpace, and a C-RNTI, an MCS-C-RNTI, or a CS-RNTI, then the UE monitors PDCCH candidates for DCI format 0_0 and DCI format 1_0 with CRC scrambled by the C-RNTI, the MCS-C-RNTI, or the CS-RNTI in the one or more search space sets in a slot where the UE monitors PDCCH candidates for at least a DCI format 0_0 or a DCI format 1_0 with CRC scrambled by SI-RNTI, RA-RNTI, MsgB-RNTI, or P-RNTI.

If a UE is provided one or more search space sets by corresponding one or more of searchSpaceZero, searchSpaceSIB1, searchSpaceOtherSystemInformation, pagingSearchSpace, ra-SearchSpace, or a CSS set by PDCCH-Config, and a SI-RNTI, a P-RNTI, a RA-RNTI, a MsgB-RNTI, a SFI-RNTI, an INT-RNTI, a TPC-PUSCH-RNTI, a TPC-PUCCH-RNTI, or a TPC-SRS-RNTI, then for a RNTI from any of these RNTIs, the UE does not expect to process information from more than one DCI format with CRC scrambled with the RNTI per slot.

In an aspect of this disclosure, pertaining to repeater common or initial search space, the repeater 202 (e.g., a network node) is configured or preconfigured with repeater search spaces for decoding repeater control information. The repeater is equipped with a transceiver with limited UE capability to synchronize to the network (e.g., base station 102) and to decode part of the Uu link physical channels. The network (pre-)configures the repeater with configuration of two search spaces, one being a common or initial search space, and the other is a repeater specific search space. The repeater 202 may implement Rel17 UE procedure for initial access, detect SSB, synchronize to the network, decode physical broadcast channel (PBCH), and retrieve MIB information.

The repeater 202 in the wireless communications system 100 can be (pre-)configured with a repeater common CORESET (CREP-CORESET) (e.g., with a specific controlResourceSetId), located on a predefined location in the time and frequency grid with known aggregation level (AL) for decoding the repeater common downlink control information (DCI) format (e.g., DCI format 2_7) whose cyclic redundancy check (CRC) is scrambled with pre-known RNTI/ID (e.g., CREP-RNTI) defined by the network operator. This can be common for all repeaters in the network, and with known rate matching information to avoid the blind search at the repeater, allowing for fast DCI decoding, and applying the control configuration on the forwarded link with low latency.

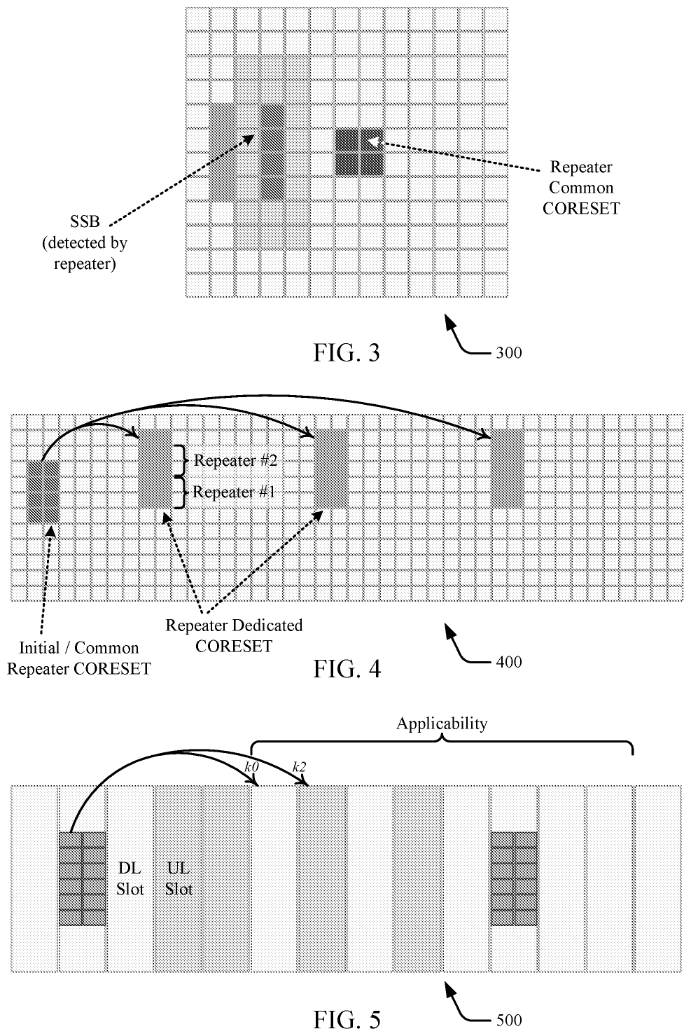

FIG. 3 illustrates an example 300 of a repeater common CORESET location that supports network controlled repeater configuration in accordance with aspects of the present disclosure. This example shows the location of the common search space to be monitored by the repeaters in the network after detecting SSB and synchronizing to the network. It is beneficial to map the CORESET REs close to the SSB (e.g., in the initial BWP) and using the same spatial filter with beam correspondence to the detected SSB beam, so that the estimated channel on PBCH can be reused for equalizing the CORESET sub-carriers in order to preserve the resource elements (REs) for control information without or with less demodulation reference signal (DMRS) overhead.

In an implementation, no demodulation reference signal (DMRS) is transmitted within the repeater common CORESET, and a quasi co-location (QCL) to PBCH DMRS is assumed, so that the channel information that is retrieved from PBCH DMRS as the location of the common CORESET is close to the SSB and within the SSB frequency band. In another implementation a predefined DMRS is distributed on predefined RE locations for accurate channel estimation. Alternatively, the periodicity of the common CORSET is higher than the SSB periodicity, such that multiple common CORESET occasions occur between SSB bursts.

The repeater common DCI in the common CORESET carries initial or common control information for the repeaters in the network, and contains the location and the size of the repeater dedicated CORESET, the periodicity of the repeater dedicated CORESET, DMRS information or QCL assumption to the corresponding PBCH DMRS or other RS, aggregation level (AL) of the repeater dedicated CORESET, SCS of the repeater CORESET, BWP, etc. The repeaters are expected to be deployed on fixed locations relative to the base station, and the link that carries the control information is expected to be constant or semi-constant with low time variation. However, a flexible configuration of the repeater dedicated CORESET with different aggregation levels, periodicity, etc. can provide flexibility for the repeater CORESET detection performance, which may depend on the network requirements and the deployment scenario.

As an example, Table T1 illustrates some of the information carried by the repeater common DCI (DCI format 2_7):

TABLE T1
Repeater Common DCI (DCI format 2_7) Information

| | Length |
|---|---|
| Parameter | (bits) |
| AL of the repeater dedicated CORESET | 2 |
| SCS of the repeater dedicated CORESET | 3 |
| First slot of the repeater dedicated CORESET (as an offset | 4 |
| to the common CORESET slot) | |
| First symbol of the repeater dedicated CORESET | 3 |
| First resource block (RB) of repeater the dedicated CORESET | 6 |
| (as an offset to first RB in the common CORESET) | |
| Periodicity of repeater the dedicated CORESET (number of | 4 |
| slots between two CORESET occasions) | |
| DMRS for repeater dedicated CORESET | 2 |
| TCI for receiving dedicated CORESET | 2 |
| CBW/ BWP of the dedicated CORESET | 3 |

A few bits (e.g., 2 bits as shown in the table above) can be signaled to indicate the DMRS on the repeater dedicated CORESET (e.g., 00 indicates no DMRS and the channel is retrieved based on a QCL assumption to the previous monitoring slot (SSB, or common CORESET)). Other values may indicate pre-defined configurations of DMRS in the repeater CORESET. In another implementation, the DMRS of the dedicated CORESET follows the configuration indicated in CORESET0 and SSB. The number of RBs and symbols used for the common CORESET depends on the predefined AL, modulation and coding, rate matching information, etc. For example, to carry the above-mentioned information bits with quadrature phase shift keying (QPSK) modulation and a ⅓ code rate with no DMRS, four RBs are required which can be sent on one or more symbols. In one implementation, common DCI may carry information about an ON/OFF function to be used by the repeater depending on its ID, such that each repeater applies an ON/OFF pattern following a combination of the indicated ON/OFF function and the identity of the repeater.

In an example, the repeater common DCI may also indicate one or more of the following: a duration for which the DCI is applicable (e.g., duration can be indicated as multiple of a time unit, where the time unit is a slot, repeater common DCI occasion, etc.); a discontinuous reception (DRX) configuration, where the repeater only monitors for repeater dedicated DCIs within the determined active time of a DRX cycle, and the DRX cycle and the corresponding active time of the DRX cycle are determined based on the DRX configuration indication indicated in the repeater common DCI; and a repeater group index. The repeater common DCI may have up to ‘N’ repeater dedicated indications, where each repeater dedicated indication comprises of set of indications corresponding to a repeater group index.

The location of the repeater dedicated CORESET in the frequency and time is determined from the indications of the first slot, first symbol in the slot, and first RB in the slot. Each repeater CCEs (associated with the dedicated CORESET) start with an offset related to a combination of the indicated AL and the pre-defined REP-RNTI, such that each repeater monitors the DCI starting with the corresponding RB (similar CCE index determination rules as described in TS 38.213 clause 10.1 can be reused). An example equation is provided for the CCE index calculation for PDCCH candidates with aggregation level ‘L’ of a search space. For a search space set s associated with CORESETp, the CCE indexes for aggregation level L corresponding to PDCCH candidate m_{s,n}_{_{CI}}^{(L)} of the search space set in slot n_{s,f}^{μ} for an active DL BWP of a serving cell corresponding to carrier indicator field value n_{CI} are given by:

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

where
for any CSS,

$${Y}_{p , {n}_{s , f}^{μ}} = 0 ;$$

for a USS,

$${Y}_{p , {n}_{s , f}^{μ}} = ( {A}_{p} \cdot {Y}_{p , {n}_{s , f}^{μ} - 1} ) mod D ,$$

Yₚ₋₁=n_{RNTI}≠0, Aₚ=39827 for pmod3=0, Aₚ=39829 for pmod3=1, Aₚ=39839 for pmod3=2, and D=65537;
i=0, . . . , L−1;
N_{CCE,p} is the number of CCEs, numbered from 0 to N_{CCE,p}−1, in CORESETp and, if any, per RB set;
n_{CI} is the carrier indicator field value if the UE is configured with a carrier indicator field by CrossCarrierSchedulingConfig for the serving cell on which PDCCH is monitored; otherwise, including for any CSS, n_{CI}=0;
m_{s,n}_{_{CI}}^{(L)}=0, . . . , M_{s,n}_{_{CI}}^{(L)}−1, where M_{s,n}_{_{CI}}^{(L)} is the number of PDCCH candidates the UE is configured to monitor for aggregation level L of a search space sets for a serving cell corresponding to n_{CI};
for any CSS, M_{s,max}^{(L)}=M_{s,0}^{(L)};
for a USS, M_{s,max}^{(L)} is the maximum of M_{s,n}_{_{CI}}^{(L)} over all configured n_{CI} values for a CCE aggregation level L of search space set s;
the RNTI value used for n_{RNTI} is the C-RNTI, and the n_{RNTI} can be set to ‘REP-RNTI’.

Alternatively, if the repeater is equipped with a transceiver that can decode SSB, PDCCH as well as PDSCH, the common or initial control information and/or configuration may be signaled using SIB. After detecting the SSB, CORESETO, the repeater decodes the SIBs carried by the PDSCH, in which a repeater common configuration for decoding the repeater specific CORESET is signaled to the repeaters. Below is an example of the repeater configuration carried by SIB as part of PDCCH-ConfigCommon.

| | |
|---|---|
| PDCCH-ConfigCommon ::= | SEQUENCE { |
| commonControlResourcesSets | SEQUENCE (SIZE(1..2)) OF ControlResourceSet, |
| commonSearchSpaces | SEQUENCE (SIZE(1..4)) OF SearchSpace, |
| searchSpaceSIB1 | SearchSpaceId, |
| searchSpaceOtherSystemInformation | SearchSpaceId, |
| pagingSearchSpace | SearchSpaceId, |
| repeaterSearchSpace | SearchSpaceId, |
| ra-ControlResourceSet | ControlResourceSetId, |
| ra-SearchSpace | SearchSpaceId, |

...
}

Where the repeater search space configuration may carry the information for decoding the repeater dedicated CORESET as in the example below:

| | |
|---|---|
| repeaterSearchSpace ::= | SEQUENCE { |
| controlResourceSetId | ControlResourceSetId |
| monitoringSlotPeriodicityAndOffset | CHOICE {sl1, sl2, ... |
| aggregationLevel | CHOICE {al1, al2, ....}, |
| RbOffset | CHOICE {0, 1, ....}, |
| symbolOffset | CHOICE {0, 1, ....}, |
| repSpecPdcch-dmrs | CHOICE {0, 1, 2, 3} |

.
.
}

In an aspect of this disclosure, pertaining to repeater dedicated search space, the repeater 202 (e.g., a network node) is (pre-)configured with repeater search spaces for decoding repeater control information. The repeater is equipped with a transceiver with limited UE capability to decode SSB and PDCCH. The repeater is (pre-)configured with two search spaces, one is a common or initial search space and another one is a repeater dedicated search space. The repeater may implement Rel17 UE procedure for initial access, detect SSB, synchronize to the network, decode PBCH, retrieve MIB information for decoding CORESET0, and decode initial or common repeater CORESET. The repeaters in the network are (pre-)configured with a repeater dedicated CORESET (REP-CORESET) via the initial CORESET and/or SIB (e.g., with a specific controlResourceSetId, DCI format (e.g., DCI format 2_7A) having CRC scrambled with pre-known RNTI/ID (REP-RNTI) defined by the network operator for each deployed repeater. The location of the CORESET, search space configuration, and periodicity of the repeater dedicated CORESET are signaled by the network via repeater initial CORESET and/or via SIB. In another implementation, the periodicity of the repeater dedicated CORESET follows the UE specific periodicity, for example, according to the parameter monitoringSlotPeriodicityAndOffset.

FIG. 4 illustrates an example 400 of the repeater CORESET periodicity and an indication of repeater dedicated CORESET configuration that supports network controlled repeater configuration in accordance with aspects of the present disclosure. This example shows the location of the repeater dedicated search space to be decoded by each repeater in the network after detecting SSB, synchronizing to the network, and receiving repeater initial or common search space configuration. The repeater estimates the channel on the repeater dedicated CORESET based on DMRS information or QCL assumption indicated in the initial CORESET.

The location of the repeater dedicated CORESET in the frequency and time is signaled via initial CORESET and/or SIB, where the signaling contains an indication of the first slot, first symbol in the slot, and first RB in the slot. Each repeater CCEs start with an offset related to a combination of the aggregation level (AL), signaled via the repeater initial or common CORESET and/or the SIB, and a pre-defined REP-RNTI, such that each repeater monitors the DCI (e.g. DCI format 7_2A) starting with the corresponding RB. For example, with ALL for one CCE, a repeater with REP-RNTI=0 monitors the DCI starting with the indicated first RB, while a repeater with REP-RNTI=3, monitors DCI starting with RB offset by three RBs from the indicated first RB in the initial or common CORESET, etc. The repeater dedicated CORESET periodicity is indicated via the initial CORESET with the number of slots between two successive CORESET locations. For example, four bits are used to indicate the periodicity of the repeater dedicated CORESET with a maximum separation of sixteen slots between two occasions with an indication granularity of one slot.

FIG. 5 illustrates an example 500 of time information indication that supports network controlled repeater configuration in accordance with aspects of the present disclosure. The Repeater dedicated DCI in the CORESET carries the dynamic control information for the repeater to be applied on the forwarded link between the base station and the UE. The forwarded link contains ON/OFF information for switching the repeater ON or OFF for efficient interference management, as well as Tx power information for UL between the repeater and the base station, and DL between the repeater and the UE. The forwarded link also contains TCI information for Tx/Rx beamforming of the forwarded signal to or from the UE, SFI information for dynamic TDD, timing information (e.g., the first DL slot offset for the control information to be applied (k0) and for the first UL slot (k1,k2)), and applicability information in a number of DL/UL slots for the control information to be applied, as shown in FIG. 5.

As an example, Table T2 illustrates example content of DCI (DCI format 2_7A) carried by repeater CORESET:

TABLE T2
Repeater CORESET DCI (DCI format 2_7A) Content

| | Length |
|---|---|
| Parameter | (bits) |
| SFI for dynamic TDD | 8 |
| TCI for both forwarded DL and UL | 8 |
| ON/OFF | 1 |
| ON/OFF pattern | 3 |
| Tx power | 6 |
| k0, k1, k2 for forwarded DL and UL slot offset | 4 |
| Applicability duration (#slots) | 4 |
| Periodicity Termination | 1 |
| Repeater ID update | 5 |

In an implementation, the ON/OFF information is explicitly indicated in DCI. In another implementation, the ON/OFF information is indicated using Tx Power information, where a value of 0 of the Tx power field indicates switching the repeater OFF, while other values indicate switching the repeater ON. The applicability information indicates the number of slots for the control information to be applied on the forwarded signal. In an implementation, the information is explicitly signaled for DL and UL. In another implementation the applicability of the control information corresponds to the CORESET periodicity (e.g., the applicability is valid until a deterministic amount of time, which can be one or more slots after the next repeater CORESET occasion). The repeater may be indicated with a bit field in the DCI for terminating the periodic repeater CORESET or for expecting an update of the periodicity and/or location information, then the repeater is expected to receive and monitor a repeater common CORESET that carries updated configuration of the repeater dedicated CORESET on the repeater common search space. In an implementation, the ID of the repeater is updated and signaled in the dedicated DCI. This ID can be applied for decoding the next set of CORESET monitoring occasions.

Alternatively, if the repeater has not received a DCI in the common CORESET for a duration of time (e.g., ‘N’ consecutive available common CORESET occasions), the repeater falls back to or uses a default set of parameters for determining the dedicated CORSET configuration parameters, such as AL, DMRS, etc. In a further alternative configuration, the repeater is implemented with a pre-known location of the repeater dedicated CORESET. The repeater is not expected to monitor the common CORESET and is (pre-)configured to monitor only the repeater dedicated CORESET at pre-known occasions, with known AL, DCI size, known TCI, and known DMRS configuration, etc.

In an aspect of network controlled repeater configuration, a common CORESET and a dedicated CORESET overlap. For example, the repeater is not expected to have a repeater dedicated CORESET overlap with a common CORESET in time and or frequency. In the case of such overlap, the repeater would not monitor or decode any PDCCH candidate associated with the repeater dedicated CORESET. In another aspect of multi-transmission-reception points (TRPs), the repeater can be (pre-)configured with at least two repeater dedicated CORESETs, where, within a duration of time (e.g., one dedicated CORESET period), a repeater dedicated DCI of a first CORESET may indicate a first TCI for forwarded DL and UL; a repeater dedicated DCI of a second CORESET may indicate a second TCI for forwarded DL and UL; and the first and the second TCIs are different.

In another example, the repeater can be (pre-)configured with at least two repeater dedicated CORESETs, where a first subset of indications in a repeater common DCI is applicable to the at least two repeater dedicated CORESETs (e.g., AL, periodicity), and a second subset of indications in the repeater common DCI provides individual indications applicable to each of the repeater dedicated CORESETs (e.g., First slot/symbol/RB of the repeater dedicated CORESET, DMRS for repeater dedicated CORESET, TCI for receiving dedicated CORESET). In another example, the repeater is not expected to receive two DCIs corresponding to a first dedicated CORESET and a second dedicated CORESET, where a subset of indicated parameters (e.g., the ON-OFF pattern) indicated by the first DCI is different than that of the second DCI, where the first DCI and the second DCI are received in a time unit (e.g., slot, span, CORESET period).

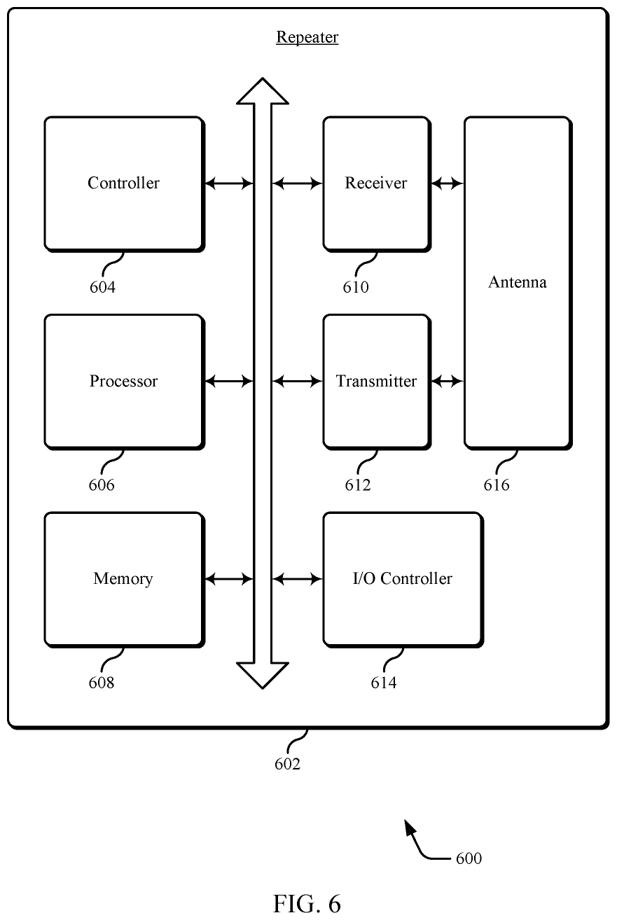

FIG. 6 illustrates an example of a block diagram 600 of a device 602 that supports network controlled repeater configuration in accordance with aspects of the present disclosure. The device 602 may be an example of a repeater node or device as described herein. The device 602 may support wireless communication and/or control signaling with one or more base stations 102, UEs 104, or any combination thereof. The device 602 may include components for bi-directional communications including components for transmitting and receiving communications, such as a controller 604, a processor 606, a memory 608, a receiver 610, a transmitter 612, and an I/O controller 614. These components may be in electronic communication or otherwise coupled (e.g., operatively, communicatively, functionally, electronically, electrically) via one or more interfaces (e.g., buses).

The controller 604, the receiver 610, the transmitter 612, or various combinations thereof or various components thereof may be examples of means for performing various aspects of the present disclosure as described herein. For example, the controller 604, the receiver 610, the transmitter 612, or various combinations or components thereof may support a method for performing one or more of the functions described herein.

In some implementations, the controller 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally or alternatively, in some implementations, the controller 604, the receiver 610, the transmitter 612, or various combinations or components thereof may be implemented in code (e.g., as communications management software or firmware) executed by the processor 606. If implemented in code executed by the processor 606, the functions of the controller 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the controller 604 may be configured to perform various operations (e.g., receiving, monitoring, transmitting) using or otherwise in cooperation with the receiver 610, the transmitter 612, or both. For example, the controller 604 may receive information from the receiver 610, send information to the transmitter 612, or be integrated in combination with the receiver 610, the transmitter 612, or both to receive information, transmit information, or perform various other operations as described herein. Although the controller 604 is illustrated as a separate component, in some implementations, one or more functions described with reference to the controller 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the controller 604 may support wireless communication and/or control signaling at a device (e.g., the device 602, a repeater) in accordance with examples as disclosed herein. The controller 604 and/or other device components may be configured as or otherwise support an apparatus, such as a repeater, including a receiver to: receive a first configuration of common control search space; receive a second configuration of control search space for control information, the first configuration of the common control search space indicating where to locate the second configuration of the control search space; a controller to: decode the control information from the second configuration of the control search space as repeater downlink control information; and apply the control information on a forwarded link between a base station and a user equipment.

Additionally, the apparatus (e.g., a repeater) includes any one or combination of: a repeater common control resource set carries the repeater downlink control information located in the common control search space of the first configuration. The control search space of the second configuration is a dedicated search space, and a repeater dedicated control resource set carries repeater dedicated downlink control information located in the dedicated search space. A repeater common control resource set carries the repeater downlink control information that indicates how to decode the second configuration of the control search space. The receiver is configured to receive, in a system information block, a third configuration of a repeater dedicated control resource set that includes decoding information to decode repeater dedicated downlink control information in the repeater dedicated control resource set. A cyclic redundancy check of the repeater downlink control information is scrambled with a pre-defined common repeater radio network temporary identity which is common for multiple repeaters. A cyclic redundancy check of repeater dedicated downlink control information in a repeater dedicated control resource set is scrambled with a pre-defined repeater radio network temporary identity specific for the repeater. Repeater dedicated control channel elements start with an offset related to a combination of an aggregation level, signaled via a repeater common downlink control information, and a pre-defined repeater radio network temporary identity, and wherein the controller is configured to monitor repeater dedicated downlink control information starting from a corresponding resource block offset to an indicated first resource block. A repeater common control resource set is allocated within bandwidth of a synchronization signal broadcast channel in an initial bandwidth part with a predefined time offset to a last symbol of the synchronization signal broadcast channel. The repeater downlink control information carried by a repeater dedicated control resource set includes side control information to be applied on the forwarded link between the base station and the user equipment, the side control information including one or more of timing information, spatial information, power control information, or ON/OFF information. The ON/OFF information is implicitly indicated by a value of the power control information, a power control field of zero indicating an OFF state and the power control field of non-zero indicating an ON state.

The controller 604 and/or other device components may be configured as or otherwise support a means for wireless communication and/or control signaling at a repeater, including receiving a first configuration of common control search space; receiving a second configuration of control search space for control information, the first configuration of the common control search space indicating where to locate the second configuration of the control search space; decoding the control information from the second configuration of the control search space as repeater downlink control information; and applying the control information on a forwarded link between a base station and a user equipment.

Additionally, wireless communication at the repeater includes any one or combination of: a repeater common control resource set carries the repeater downlink control information located in the common control search space of the first configuration. The control search space of the second configuration is a dedicated search space, and a repeater dedicated control resource set carries repeater dedicated downlink control information located in the dedicated search space. A repeater common control resource set carries the repeater downlink control information that indicates how to decode the second configuration of the control search space. The receiver is configured to receive, in a system information block, a third configuration of a repeater dedicated control resource set that includes decoding information to decode repeater dedicated downlink control information in the repeater dedicated control resource set. A cyclic redundancy check of the repeater downlink control information is scrambled with a pre-defined common repeater radio network temporary identity which is common for multiple repeaters. A cyclic redundancy check of repeater dedicated downlink control information in a repeater dedicated control resource set is scrambled with a pre-defined repeater radio network temporary identity specific for the repeater. Repeater dedicated control channel elements start with an offset related to a combination of an aggregation level, signaled via a repeater common downlink control information, and a pre-defined repeater radio network temporary identity, and wherein the controller is configured to monitor repeater dedicated downlink control information starting from a corresponding resource block offset to an indicated first resource block. A repeater common control resource set is allocated within bandwidth of a synchronization signal broadcast channel in an initial bandwidth part with a predefined time offset to a last symbol of the synchronization signal broadcast channel. The repeater downlink control information carried by a repeater dedicated control resource set includes side control information to be applied on the forwarded link between the base station and the user equipment, the side control information including one or more of timing information, spatial information, power control information, or ON/OFF information. The ON/OFF information is implicitly indicated by a value of the power control information, a power control field of zero indicating an OFF state and the power control field of non-zero indicating an ON state.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

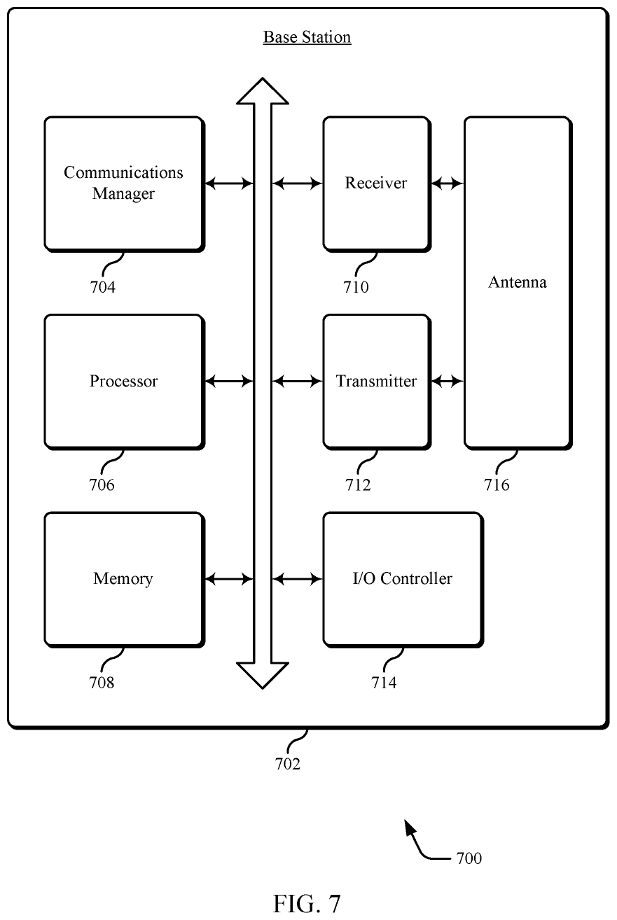

FIG. 7 illustrates an example of a block diagram 700 of a device 702 that supports network controlled repeater configuration in accordance with aspects of the present disclosure. The device 702 may be an example of a base station 102, such as a gNB as described herein. The device 702 may support wireless communication and/or network signaling with one or more base stations 102, UEs 104, NTSs 108, repeaters, or any combination thereof. The device 702 may include components for bi-directional communications including components for transmitting and receiving communications, such as a communications manager 704, a processor 706, a memory 708, a receiver 710, a transmitter 712, and an I/O controller 714. These components may be in electronic communication or otherwise coupled (e.g., operatively, communicatively, functionally, electronically, electrically) via one or more interfaces (e.g., buses).

The communications manager 704, the receiver 710, the transmitter 712, or various combinations thereof or various components thereof may be examples of means for performing various aspects of the present disclosure as described herein. For example, the communications manager 704, the receiver 710, the transmitter 712, or various combinations or components thereof may support a method for performing one or more of the functions described herein.

In some implementations, the communications manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally or alternatively, in some implementations, the communications manager 704, the receiver 710, the transmitter 712, or various combinations or components thereof may be implemented in code (e.g., as communications management software or firmware) executed by the processor 706. If implemented in code executed by the processor 706, the functions of the communications manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 704 may be configured to perform various operations (e.g., receiving, monitoring, transmitting) using or otherwise in cooperation with the receiver 710, the transmitter 712, or both. For example, the communications manager 704 may receive information from the receiver 710, send information to the transmitter 712, or be integrated in combination with the receiver 710, the transmitter 712, or both to receive information, transmit information, or perform various other operations as described herein. Although the communications manager 704 is illustrated as a separate component, in some implementations, one or more functions described with reference to the communications manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the communications manager 704 may support wireless communication at a device (e.g., the device 702, base station) in accordance with examples as disclosed herein. The communications manager 704 and/or other device components may be configured as or otherwise support an apparatus, such as a base station, including a transceiver; a processor coupled to the transceiver, the processor and the transceiver configured to cause the apparatus to: transmit, to a repeater, a first configuration of common control search space; and transmit, to the repeater, a second configuration of control search space for control information, the first configuration of the common control search space indicating to the repeater where to locate the second configuration of the control search space and decode the control information from the second configuration of the control search space as repeater downlink control information usable to control a forwarded link between the apparatus and the user equipment.

The communications manager 704 and/or other device components may be configured as or otherwise support a means for wireless communication at a base station, including transmitting, to a repeater, a first configuration of common control search space; and transmitting, to the repeater, a second configuration of control search space for control information, the first configuration of the common control search space indicating to the repeater where to locate the second configuration of the control search space and decode the control information from the second configuration of the control search space as repeater downlink control information usable to control a forwarded link between the apparatus and the user equipment.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

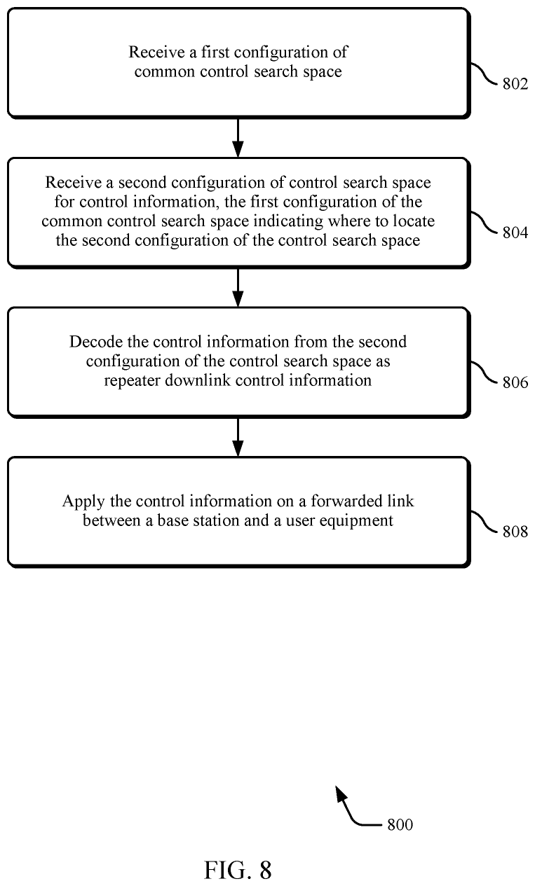

FIG. 8 illustrates a flowchart of a method 800 that supports network controlled repeater configuration in accordance with aspects of the present disclosure. The operations of the method 800 may be implemented by a device or its components as described herein. For example, the operations of the method 800 may be performed by a device, such as a repeater as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include receiving a first configuration of common control search space. The operations of 802 may be performed in accordance with examples as described herein. In some implementations, aspects of the operations of 802 may be performed by a device as described with reference to FIGS. 1 and 2.

At 804, the method may include receiving a second configuration of control search space for control information, the first configuration of the common control search space indicating where to locate the second configuration of the control search space. The operations of 804 may be performed in accordance with examples as described herein. In some implementations, aspects of the operations of 804 may be performed by a device as described with reference to FIGS. 1 and 2.

At 806, the method may include decoding the control information from the second configuration of the control search space as repeater downlink control information. The operations of 806 may be performed in accordance with examples as described herein. In some implementations, aspects of the operations of 806 may be performed by a device as described with reference to FIGS. 1 and 2.

At 808, the method may include applying the control information on a forwarded link between a base station and a user equipment. The operations of 808 may be performed in accordance with examples as described herein. In some implementations, aspects of the operations of 808 may be performed by a device as described with reference to FIGS. 1 and 2.

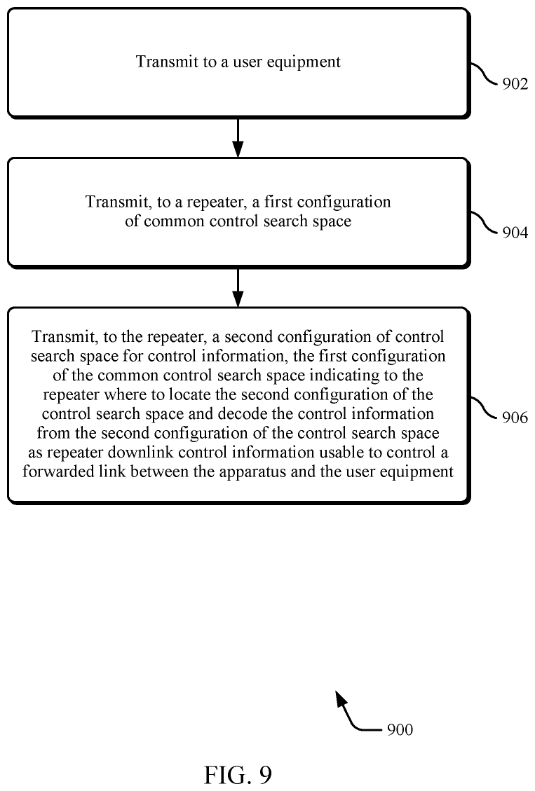

FIG. 9 illustrates a flowchart of a method 900 that supports network controlled repeater configuration in accordance with aspects of the present disclosure. The operations of the method 900 may be implemented by a device or its components as described herein. For example, the operations of the method 900 may be performed by a base station, such as a gNB as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include transmitting to a user equipment. The operations of 902 may be performed in accordance with examples as described herein. In some implementations, aspects of the operations of 902 may be performed by a device as described with reference to FIGS. 1 and 2.

At 904, the method may include transmitting, to a repeater, a first configuration of common control search space. The operations of 904 may be performed in accordance with examples as described herein. In some implementations, aspects of the operations of 904 may be performed by a device as described with reference to FIGS. 1 and 2.

At 906, the method may include transmitting, to the repeater, a second configuration of control search space for control information, the first configuration of the common control search space indicating to the repeater where to locate the second configuration of the control search space and decode the control information from the second configuration of the control search space as repeater downlink control information usable to control a forwarded link between the apparatus and the user equipment. The operations of 906 may be performed in accordance with examples as described herein. In some implementations, aspects of the operations of 906 may be performed by a device as described with reference to FIGS. 1 and 2.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A repeater for wireless communication, comprising:
at least one memory; and
at least one processor coupled with the at least one memory and configured to cause the repeater to:
receive a first configuration of common control search space;
receive a second configuration of control search space for control information, the first configuration of the common control search space indicating where to locate the second configuration of the control search space;
decode the control information from the second configuration of the control search space as repeater downlink control information (DCI); and
apply the control information on a link between a base station and a user equipment.

2. The repeater of claim 1, wherein a repeater common control resource set carries the repeater DCI located in the common control search space of the first configuration.

3. The repeater of claim 1, wherein the control search space of the second configuration is a dedicated search space, and a repeater dedicated control resource set carries repeater dedicated DCI located in the dedicated search space.

4. The repeater of claim 1, wherein a repeater common control resource set carries the repeater DCI that indicates how to decode the second configuration of the control search space.

5. The repeater of claim 1, wherein the at least one processor is configured to cause the repeater to receive, in a system information block, a third configuration of a repeater dedicated control resource set that includes decoding information to decode repeater dedicated DCI in the repeater dedicated control resource set.

6. The repeater of claim 1, wherein a cyclic redundancy check of the repeater DCI is scrambled with a pre-defined common repeater radio network temporary identity which is common for multiple repeaters.

7. The repeater of claim 1, wherein a cyclic redundancy check of repeater dedicated DCI in a repeater dedicated control resource set is scrambled with a pre-defined repeater radio network temporary identity specific for the repeater.

8. The repeater of claim 1, wherein repeater dedicated control channel elements start with an offset related to a combination of an aggregation level, signaled via a repeater common DCI, and a pre-defined repeater radio network temporary identity, and wherein the cat least one processor is configured to cause the repeater to monitor repeater dedicated DCI starting from a corresponding resource block offset to an indicated first resource block.

9. The repeater of claim 1, wherein a repeater common control resource set is allocated within bandwidth of a synchronization signal broadcast channel in an initial bandwidth part with a predefined time offset to a last symbol of the synchronization signal broadcast channel.

10. The repeater of claim 1, wherein the repeater downlink control information carried by a repeater dedicated control resource set includes side control information to be applied on the link between the base station and the user equipment, the side control information including one or more of timing information, spatial information, power control information, or ON/OFF information.

11. The repeater of claim 10, wherein the ON/OFF information is implicitly indicated by a value of the power control information, a power control field of zero indicating an OFF state and the power control field of non-zero indicating an ON state.

12. A base station for wireless communication, comprising:
at least one memory; and
at least one processor coupled with the at least one memory and configured to cause the base station to:
transmit, to a repeater, a first configuration of common control search space; and
transmit, to the repeater, a second configuration of control search space for control information, the first configuration of the common control search space indicating to the repeater where to locate the second configuration of the control search space and decode the control information from the second configuration of the control search space as repeater downlink control information (DCI) usable to control a link between the base station and a user equipment.

13. A method at a repeater node, the method comprising:
receiving a first configuration of common control search space;
receiving a second configuration of control search space for control information, the first configuration of the common control search space indicating where to locate the second configuration of the control search space;
decoding the control information from the second configuration of the control search space as repeater downlink control information (DCI); and
applying the control information on a link between a base station and a user equipment.

14. The method of claim 13, wherein a repeater common control resource set carries the repeater DCI located in the common control search space of the first configuration.

15. The method of claim 13, wherein the control search space of the second configuration is a dedicated search space, and a repeater dedicated control resource set carries repeater dedicated DCI located in the dedicated search space.

16. The method of claim 13, wherein a repeater common control resource set carries the repeater downlink control information that indicates how to decode the second configuration of the control search space.

17. The method of claim 13, further comprising receiving, in a system information block, a third configuration of a repeater dedicated control resource set that includes decoding information to decode repeater dedicated DCI in the repeater dedicated control resource set.

18. The method of claim 13, wherein a cyclic redundancy check of the repeater DCI is scrambled with a pre-defined common repeater radio network temporary identity which is common for multiple repeaters.

19. The method of claim 13, wherein a cyclic redundancy check of repeater dedicated DCI in a repeater dedicated control resource set is scrambled with a pre-defined repeater radio network temporary identity specific for the repeater.

20. (canceled)

21. A processor for wireless communication, comprising:
at least one controller coupled with at least one memory and configured to cause the processor to:
receive a first configuration of common control search space;
receive a second configuration of control search space for control information, the first configuration of the common control search space indicating where to locate the second configuration of the control search space;
decode the control information from the second configuration of the control search space as repeater downlink control information (DCI); and
apply the control information on a link between a base station and a user equipment.
